(19) United States
(12) Patent Application Publication
(10) Pub. No.: US 2026/0064365 A1
(43) Pub. Date: Mar. 5, 2026

(54) MULTIPLIER FOR MASKING-BASED MODULAR MULTIPLICATION OPERATION, ENCRYPTION DEVICE INCLUDING THE SAME AND METHOD

(71) Applicant: SAMSUNG ELECTRONICS CO., LTD., Suwon-si (KR)

(72) Inventor: Sungkyoung Kim, Suwon-si (KR)

(73) Assignee: SAMSUNG ELECTRONICS CO., LTD., Suwon-si (KR)

(21) Appl. No.: 19/308,981

(22) Filed: Aug. 25, 2025

(30) Foreign Application Priority Data
Aug. 30, 2024 (KR) 10-2024-0118063

(51) Int. Cl. G06F 7/523; G06F 7/58; H04L 9/30

(52) U.S. Cl. CPC G06F 7/523; G06F 7/588; H04L 9/3006

(57) ABSTRACT

A multiplier device includes a masking circuit that masks a multiplicand and a multiplier based on a random number, to obtain a masked multiplicand and a masked multiplier, respectively, a first intermediate operation circuit that obtains a masking term defined based on the masked multiplicand, the masked multiplier, and the random number, and to obtain a multiple random number result through a multiplication operation of the random number and the masking term, a second intermediate operation circuit that obtains a partial product result for the masked multiplicand and the masked multiplier, and a multiple modulus result for a modulus and a quotient of the modulus, and an accumulation circuit that accumulates the partial product result, the multiple modulus result, and the multiple random number result up to an intermediate result of a previous loop.

### CROSS-REFERENCE TO RELATED APPLICATION

This application is based on and claims priority under 35 U.S.C. § 119 to Korean Patent Application No. 10-2024-0118063 filed on Aug. 30, 2024, in the Korean Intellectual Property Office, the disclosure of which being incorporated by reference herein in its entirety.

### BACKGROUND

Embodiments of the present disclosure described herein relate to a multiplier for a masking-based modular multiplication operation, and an encryption device and method including the same.

A modular exponentiation operation is a fundamental operation used in various cryptographic algorithms, including a Ron Rivest, Adi Shamir, Len Adleman (RSA) algorithm. The modular exponentiation operation requires iterated modular multiplication operations. The basic modular multiplication operation requires division operations for modular operations, and the division operation requires a large computational cost.

### SUMMARY

It is an aspect to provide a multiplier for a masking-based modular multiplication operation, and an encryption device and method including the same.

According to an aspect of one or more embodiments, there is provided a multiplier device comprising a masking circuit configured to mask a multiplicand and a multiplier based on a random number, to obtain a masked multiplicand and a masked multiplier, respectively; a first intermediate operation circuit configured to obtain a masking term defined based on the masked multiplicand, the masked multiplier, and the random number, and to obtain a multiple random number result through a multiplication operation of the random number and the masking term; a second intermediate operation circuit configured to obtain a partial product result for the masked multiplicand and the masked multiplier, and a multiple modulus result for a modulus and a quotient of the modulus; and an accumulation circuit configured to accumulate the partial product result, the multiple modulus result, and the multiple random number result up to an intermediate result of a previous loop.

According to another aspect of one or more embodiments, there is provided a method of operating a multiplier device, the method comprising masking a multiplicand and a multiplier based on a random number, to obtain a masked multiplicand and a masked multiplier, respectively; obtaining a masking term defined based on the masked multiplicand, the masked multiplier, and the random number; obtaining a multiple random number result, which is a result of a multiplication operation of the random number and the masking term, a partial product result for the masked multiplicand and the masked multiplier, and a multiple modulus result for a modulus and a quotient for the modulus; and accumulating the partial product result, the multiple modulus result, and the multiple random number result up to an intermediate result of a previous loop.

According to yet another aspect of one or more embodiments, there is provided an encryption device comprising a random number generation circuit configured to generate a random number; one or more multiplier devices configured to mask a multiplicand and a multiplier based on the random number, thus obtaining a masked multiplicand and a masked multiplier, respectively, to obtain a masking term defined based on the masked multiplicand, the masked multiplier, and the random number, and to perform a modular multiplication operation based on the masked multiplicand, the masked multiplier, the random number, and the masking term; and an encryption circuit configured to perform encryption to encrypt a message based on the one or more multiplier devices, and to obtain encrypted data corresponding to the encryption.

### BRIEF DESCRIPTION OF THE FIGURES

The above and other aspects will become apparent by describing in detail embodiments thereof with reference to the accompanying drawings, in which

FIG. 1 illustrates a modular multiplication operation, according to an embodiment;

FIG. 2 illustrates an example of an encryption system, according to an embodiment;

FIG. 3 is a block diagram of a multiplier, according to some embodiments;

FIG. 4 is a flowchart of an operating method of a multiplier, according to some embodiments;

FIG. 5 is a flowchart of an operating method of a multiplier, according to some embodiments;

FIG. 6 is a block diagram of a multiplier, according to some embodiments;

FIG. 7 is a flowchart of an operating method of a multiplier, according to some embodiments;

FIG. 8 illustrates an electronic device, according to some embodiments;

FIG. 9 illustrates an encryption device, according to some embodiments;

FIG. 10 is a table comparing a mathematical computational cost of encryption algorithms, according to some embodiments; and

FIG. 11 illustrates trends of power waveforms of encryption algorithms, according to some embodiments.

### DETAILED DESCRIPTION

Hereinafter, various embodiments will be described clearly and in detail such that those skilled in the art may easily carry out the embodiments. It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a “first” element, component, region, layer or section described below could be termed a “second” element, component, region, layer or section, without departing from the spirit and scope of the present disclosure.

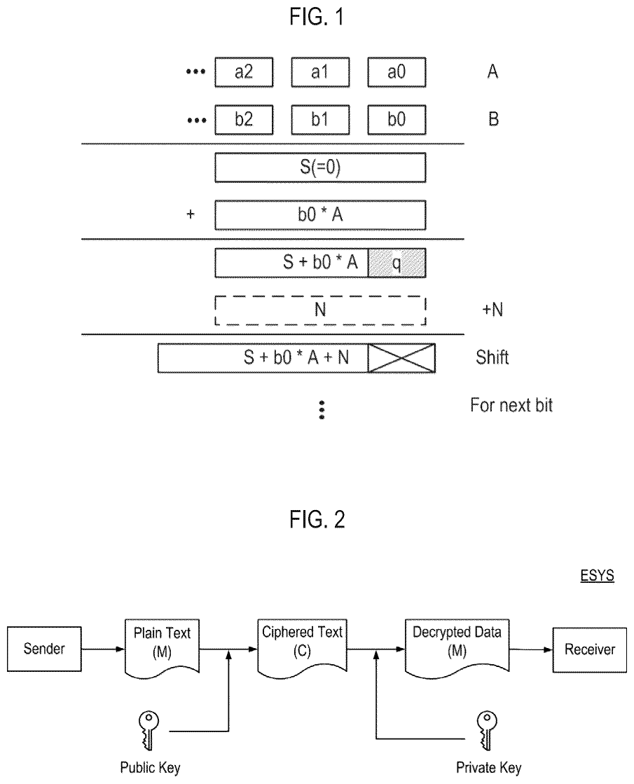

FIG. 1 is for illustrating a modular multiplication operation, according to an embodiment.

Referring to FIG. 1, a modular multiplication operation may be defined as performing a modular operation based on a modulus for the multiplication of a multiplicand and a multiplier. For example, a modular multiplication operation may be defined by Equation 1 below.

$$A \times B mod N \qquad [ Equation 1 ]$$

Here, “A” is the multiplicand, “B” is the multiplier, and “N” is the modulus. The modular multiplication operation in Equation 1 has a significant overhead in the operation of dividing by “N” to obtain the remainder associated with the multiplication of the multiplicand “A” and the multiplier “B”.

To reduce the overhead of the division operation, a Montgomery operation (or a Montgomery algorithm, or a Montgomery modular multiplication (MMM)) may be used. The Montgomery operation may reduce the overhead of the division operation by performing the modular operation through a shift instead of the division operation. The Montgomery operation may be defined by Equation 2 below.

$$MMM ( A , B , N ) = A \times B \times {R}^{- 1} mod N \qquad [ Equation 2 ]$$

Here, “R” is defined as a Montgomery constant (or, a base). For example, “R” may be defined as 2ⁿ, and “n” may be defined as a value greater than “k” (where “k” is a natural number greater than 2), which is a bit length of “N”. In Equation 2, the fact that the inverse of a Montgomery constant “R” is multiplied may mean that “n” shifts are applied to the modular multiplication operation.

In FIG. 1, which illustrates a Montgomery operation by way of example, when the multiplicand and the multiplier are each k-bit (in the case of FIG. 1, “k”=3), “S”, which is defined as an intermediate result (or a final result), is first set to an initial value “0”. A partial product operation of the multiplicand for b0, which is the least significant bit (LSB) of the multiplier, is performed, and a partial product result b0*A is generated as a result of the partial product operation.

The intermediate result “S” is added to the partial product result b0*A. In this case, the least significant bit (LSB) of the sum result S+b0*A may be defined as a quotient, and a sign of the quotient may indicate whether the modulus is added or not. In other words, the quotient may signal whether the modulus is added or not. When the quotient is “0”, the modulus is not added, but when the quotient is “1”, the modulus is added. In other words, when the quotient is “0”, it signals that the modulus is not added, and when the quotient is “1”, it signals that the modulus is added. In detail, to make the least significant bit (LSB) of the sum result S+b0*A to “0”, the modulus may be added or not depending on the sign of the quotient.

Depending on whether the modulus is added or not, the least significant bit (LSB) of the result of adding the sum result S+b0*A and the modulus “N” becomes “0”. Since the least significant bit is “0”, the sum result S+b0*A+N may be shifted by one bit.

When the above-described partial operations are iteratively performed for each bit of the multiplier, the intermediate result “S” is accumulated, and when the partial operations are completed for all bits, the intermediate result “S” at the termination point may become the final result.

Table 1 below illustrates codes for implementing the Montgomery operation as illustrated in FIG. 1.

TABLE 1

| Input | A, B, N, R |
|---|---|
| Output | ABR⁻¹ mod 2 |
| 1 | S = 0 |
| 2 | For i = 0 to l − 1 |
| 3 | qᵢ = s₀ + bᵢa₀ mod 2 |
| 4 | S = (S + bᵢA + qᵢN) / 2 |
| 5 | If (S > N) then S = S − N |
| 6 | Return S |

Table 1 above illustrates the Montgomery operation based on a Radix-2. Through the Montgomery operation, the final result S=(s₁, sₗ₋₁, . . . , s₁, s₀)₂ for the loop length “l” (where “l” is a natural number) is output. The above described “A”, “B”, and “S” may have a size of k-bits. In addition, the loop length “l” in Table 1 may be set to be the same as “k”.

First, the result “S” is set to the initial value “0” (line 1 of Table 1)

Then, in an i-th operation of the loop length “l”, the product of bᵢ corresponding to an i-bit in the multiplier and a₀ corresponding to a 0-bit in the multiplicand is added to so, which is the 0-bit of the “S”. The result of the addition is expressed as a value of “0” or “1” through modular 2. As a result, the quotient qᵢ is calculated (line 3 of Table 1).

The qᵢ indicates whether the last digit of the result of the product of the multiplicand and the multiplier in the i-th operation is “0” or “1”.

Next, in the i-th operation, the new intermediate result “S” is updated (line 4 of Table 1). In detail, the product of bᵢ corresponding to the i-th digit of the multiplier and the multiplicand “A” is added to the previous intermediate result “S”, and additionally, a modulus may be added depending on the value of qᵢ. When qᵢ is “0”, the modulus is not added. Since the sum result (S+bᵢA+qᵢN) is divided by “2”, the last digit (i.e., “0”) of the sum result is deleted. Therefore, line 4 of Table 1 may be understood as shifting the sum result (S+bᵢA+qᵢN) by one digit.

Lines 3 and 4 of Table 1 are iteratively performed with respect to the loop length “l”.

Thereafter, when the accumulation result S=(s₁, sₗ₋₁, . . . , s₁, s₀)₂ for the loop length “l” is greater than the modulus “N”, the value (line 5 in Table 1) obtained by subtracting the modulus “N” from the result “S” is calculated as the final result. Since “S” may have a value greater than or equal to “0” and less than 2N, line 5 of Table 1 subtracts the size of “S”.

The Montgomery operation based on Table 1 described above is only an example, and the Montgomery operation may be implemented in various ways to calculate Equation 2.

### Some Characteristics of the Montgomery Operation

With respect to the Montgomery constant “R”, the Montgomery operation for the modular multiplication described above may have the following characteristics.

$$MMM ( AR , BR , N ) = AR \times BR \times {R}^{- 1} mod N = ABR mod N \qquad [ Characteristic 1 ]$$

According to characteristic 1, when the multiplicand and the multiplier are multiplied by the Montgomery constant, the result of the Montgomery operation may be defined as the modular operation of the product of “A”, “B”, and “R” with the modulus “N”. In detail, characteristic 1 indicates that when the input values of the modular operation are multiplied by the Montgomery constant, the output of the Montgomery operation is also multiplied by “R”.

$$MMM ( A , {R}^{2} , N ) = A \times {R}^{2} \times {R}^{- 1} mod N = AR mod N \qquad [ Characteristic 2 ]$$

According to characteristic 2, the result of the Montgomery operation on R², which is the square of the Montgomery constant, and the multiplicand, may be defined as the modular operation of the modulus “N” with respect to the product of the multiplicand and the Montgomery constant.

Through characteristic 2, the multiplicand in a integer domain may be converted to a Montgomery domain.

$$MMM ( AR , 1 , N ) = AR \times 1 \times {R}^{- 1} mod N = A mod N \qquad [ Characteristic 3 ]$$

According to characteristic 3, the result of the Montgomery operation on the product of the multiplicand and the Montgomery constant and ‘1’ may be defined as the modular operation of the multiplicand by the modulus “N”.

Through characteristic 3, the multiplicand in the Montgomery domain may be converted to the integer domain.

FIG. 2 illustrates an example of an encryption system, according to an embodiment.

Encryption methods may generally be classified into secret key (or symmetric-key) encryption methods and public key (or asymmetric-key) encryption methods.

The secret key encryption is a method in which two communication devices encrypt and transmit data using the same secret key or decrypt received data. According to the secret key encryption method, since the two communication devices should share the same secret key, a secure key transmission communication channel is required only for the two communication devices.

In contrast, the public key encryption method encrypts and transmits data using the public key of the counterpart device with which each of the multiple communication devices wants to communicate, and decrypts the received data using the private key that is not disclosed and is held only by the device itself. Therefore, in the public key encryption method, after generating one's own public key and private key, the public key is disclosed and only the private key is safely kept, so it is easy to manage the key.

Representative public key algorithms include the a Ron Rivest, Adi Shamir, Len Adleman (RSA) algorithm, an Elliptic Curve Cryptograph (ECC) algorithm, and a Diffie-Hellman (DH) algorithm. Among these algorithms, the system to which the RSA algorithm is applied is the most widely used as a public key encryption system, and utilizes the high difficulty of solving a factorization problem. The RSA encryption systems, etc. may be used not only for encryption but also for electronic signature purposes.

The operation basically used in many encryption systems including the RSA encryption system is a modular exponentiation operation. For modular exponentiation, iterated modular multiplication operation is required.

FIG. 2 illustrates an encryption system (ESYS) based on the RSA algorithm, and the encryption system (ESYS) includes a sender and a receiver. The sender and the receiver may correspond to a communication device or may include a communication device.

The RSA encryption system generates a cipher text “C” through a modular operation using a public key (“e” and “n”) consisting of two positive integers to encrypt a plain text “M”. The encryption operation for generating the cipher text may be defined by Equation 3 below.

$$C = {M}^{e} mod n \qquad [ Equation 3 ]$$

In the case of decryption, decryption may be performed as in the following Equation 4 using a private key (“d” and “n”).

$$M = {C}^{d} mod n \qquad [ Equation 4 ]$$

Through decryption, decrypted data “M” is obtained.

As illustrated in the above Equations 3 and 4, the RSA encryption system requires modular exponentiation operations as large as the size of the public key “e” or the private key “d”. Since the modular exponentiation operation requires multiple modular multiplication operations, excessive overhead occurs with general modular operations.

Therefore, an efficient modular multiplication operation such as the Montgomery operation described above may be used.

### Side-Channel Attack

A side-channel attack attempts to find out secret information such as a key from physical signals or phenomena (e.g., power consumption, time required, etc.) associated with an encryption algorithm. To defend against the side-channel attacks, individual defense methods may be implemented for operations used in the encryption algorithm.

For example, in modular exponentiation operations (e.g., Equations 3 and 4 described above), a method of masking an exponent may be used to defend against the side-channel attacks. In this case, there is a disadvantage that approximately twice the computational cost of general modular exponentiation operations is required.

In addition, an elliptic curve digital signature algorithm (ECDSA), which is an elliptic curve DSA algorithm, calculates a signature integer “s” based on s=k⁻¹(h(m)+dr)mod N. Here, “k” is a random number, h(m) is a hash function for a message “m”, “d” is a private key, “r” is another signature integer, and “N” is a modulus.

To defend against side-channel attacks on ECDSA (e.g., simple power attack, differential power attack, correlation power attack, etc.), masking may be performed on the “dr” operation. When a 32-bit inverse operation is required, there is a problem that the computational cost required is the same as that of a 32-bit exponentiation operation.

Hereinafter, embodiments related to the Montgomery operation to which masking may be applied in a modular multiplication operation for a modular exponentiation operation are described. A random number “r” may be used for masking, and a Montgomery operation in which masking based on the random number “r” is applied according to some embodiments described below may be referred to as a ‘masking-based Montgomery operation’.

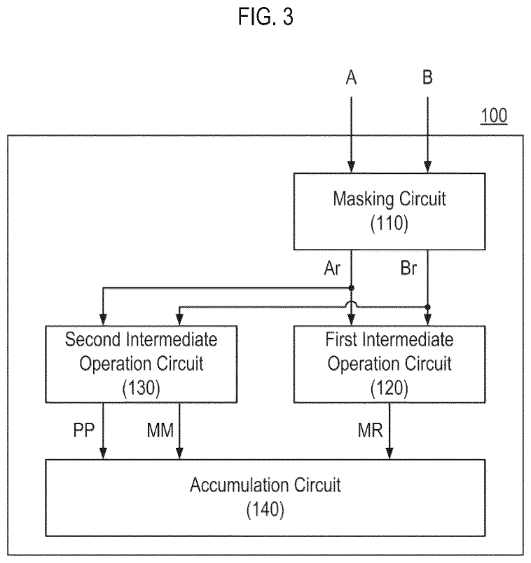

FIG. 3 is a block diagram of a multiplier, according to some embodiments.

Referring to FIG. 3, a multiplier 100 may include a masking circuit 110, a first intermediate operation circuit 120, a second intermediate operation circuit 130, and an accumulation circuit 140.

The masking circuit 110 may be configured to mask a multiplicand and a multiplier based on a random number. Through the masking circuit 110, a masked multiplicand and a masked multiplier that are masked with the random number may be obtained. When each of the multiplicand and the multiplier of the modular multiplication operation of the Equation 1 described above is masked with a random number “r”, a masked multiplicand Ar may be defined as Aᵣ=A−r, and the masked multiplier Br may be defined as Bᵣ=B−r In detail, the masked multiplicand Ar may be defined as the original multiplicand “A” minus “r”, and the masked multiplier Br may be defined as the original multiplier “B” minus “r”. Through masking based on a random number, defense against side-channel attacks on the modular multiplication operation is possible.

When the masked multiplicand and the masked multiplier are redefined in terms of the modular multiplication operation, the modular multiplication operation of Equation 1 may be redefined as Equation 5 below.

$${A}_{r} \times {B}_{r} = ( A - r ) \times ( B - r ) = AB - rA - rB + {r}^{2} = AB - r ( A + B - r ) \qquad [ Equation 5 ]$$

When Equation 5 is rearranged in terms of the product of the multiplicand and the multiplier, Equation 5 may be expressed as Equation 6 below.

$$A \times B = {A}_{r} \times {B}_{r} + r ( A + B - r ) \qquad [ Equation 6 ]$$

When the masking for the multiplicand and the multiplier, which are input values, is applied equally to the output value, the random number “r” may be subtracted from both sides of Equation 6. Depending on the subtraction of the random number “r”, Equation 6 may be expressed as Equation 7 below.

$$( A \times B ) - r = {A}_{r} \times {B}_{r} + r ( A + B - r - 1 ) = {A}_{r} \times {B}_{r} + r ( {A}_{r} + {B}_{r} + r - 1 ) \qquad [ Equation 7 ]$$

As a result, through Equations 5 to 7, it may be confirmed that when a term r(Aᵣ+Bᵣ+r−1) is added to the product result of the masked multiplicand and the masked multiplier, the result of masking the random number “r” with respect to the product of the multiplicand and the multiplier is calculated. In detail, when masking based on the random number “r” is applied to the input multiplicand and the input multiplier, the term r(Aᵣ+Bᵣ+r−1) may be added to the product of the masked multiplicand and the masked multiplier, to apply the same masking to the product of the multiplicand and the multiplier, which is an output.

The first intermediate operation circuit 120, the second intermediate operation circuit 130, and the accumulation circuit 140 according to some embodiments may be configured to perform the Montgomery operation on (A×B)−r (i.e., the value of masking the random number “r” to the product of the multiplicand and the multiplier) defined in the above described Equation 7. That is, the multiplier 100 may output (AB−r)R⁻¹ mod N as an output.

First, the first intermediate operation circuit 120 may obtain a masked multiplicand and a masked multiplier from the masking circuit 110, and may obtain a masking term defined based on the masked multiplicand, the masked multiplier, and the random number.

The masking term according to some embodiments may be defined by the following Equation 8.

$${A}_{r} + {B}_{r} + r - 1 \qquad [ Equation 8 ]$$

As defined in Equation 7, the masking term of Equation 8 may be defined to apply masking to the multiplication result of the multiplicand and the multiplier in the same manner as the input.

The first intermediate operation circuit 120 may obtain the masking term based on Equation 8.

The first intermediate operation circuit 120 may obtain a multiple random number result through a multiplication operation on the random number and the masking term. The first intermediate operation circuit 120 may output the obtained multiple random number result MR to the accumulation circuit 140. Hereinafter, in the present specification, the multiple random number result MR may be defined as a value obtained by multiplying a random number and a masking term in any form.

The second intermediate operation circuit 130 may be configured to obtain a partial product result PP for the masked multiplicand and the masked multiplier, a quotient for a modulus, and a multiple modulus result for the quotient and the modulus. Hereinafter, in the present specification, the partial product result PP may be defined as the value obtained by multiplying the masked multiplicand and the masked multiplier in any form.

According to some embodiments, the second intermediate operation circuit 130 may obtain the partial product result PP through a partial product operation of the multiplicand for the least significant bit of the masked multiplier.

According to some embodiments, the quotient obtained through the second intermediate operation circuit 130 may be defined as a sign indicating whether to add the modulus based on the intermediate result, the partial product result PP, and the multiple random number result MR. In other words, the quotient obtained through the second intermediate operation circuit 130 may signal whether to add the modulus based on the intermediate result, the partial product result PP, and the multiple random number result MR. In detail, the quotient according to some embodiments is defined by additionally considering the multiple random number result MR in addition to the intermediate result and the partial product result PP, and is distinguished from the quotient in the general Montgomery operation defined in Table 1 described above.

In more detail, the quotient in the general Montgomery operation indicates the sign of the last digit of the result of the product of the multiplicand and the multiplier, which is the partial product result PP, but the quotient in the masking-based Montgomery operation according to some embodiments indicates the sign of the last digit of the sum of the partial product result PP and the multiple random number result MR. The quotient may be considered as indicating whether to add the modulus, depending on the operation on the right-side term of Equation 7.

According to some embodiments, the second intermediate operation circuit 130 may obtain the quotient through a modular operation on the result of the sum of the intermediate result, the partial product result PP, and the multiple random number result MR. The value used for the modular operation is a radix. When the masking-based Montgomery operation is implemented based on the Radix-2 described above, the second intermediate operation circuit 130 obtains the quotient through a modular operation with a modulus of “2”.

According to some embodiments, the second intermediate operation circuit 130 may obtain a multiple modulus result MM by multiplying the quotient and the modulus. The multiple modulus result MM may be “0” or the modulus depending on the sign (e.g., “0” or “1”) of the quotient.

The second intermediate operation circuit 130 may obtain the partial product result PP, the quotient, and the multiple modulus result MM for each loop. The second intermediate operation circuit 130 may output the obtained information to the accumulation circuit 140.

In the operation of the first and second intermediate operation circuits 120 and 130 according to the above described embodiments, random number-based masking is applied, so that the calculated results may be randomized. Therefore, a defense against side-channel attacks may be obtained.

The accumulation circuit 140 may be configured to accumulate the partial product result PP, the multiple modulus result MM, and the multiple random number result MR up to the intermediate result of a previous loop. The previous loop is the loop immediately before the current loop in which the data to be accumulated are obtained or calculated. The previous loop may correspond to i−1 when the current index is “i” (where, “i” is “0” to “l”−1) within the loop length “l” in which the quotient and the intermediate result are iteratively calculated in the Montgomery operation. Therefore, the intermediate result of the previous loop may be defined as the accumulation result of the (i−1)-th loop.

The accumulation result of the current loop accumulated through the accumulation circuit 140 may be the result of adding the partial product result PP, the multiple modulus result MM, and the multiple random number result MR obtained or calculated in the current loop to the intermediate result of the previous loop.

The accumulation circuit 140 may shift the accumulation result such that the last bit of the accumulation result becomes “0” for each loop. In mathematical terms, the shift may be considered as dividing the accumulation result by “2”. When the Montgomery operation is performed in a direction of the most significant bit (MSB) from the LSB, the shift may be performed in the direction of the MSB. For example, a shift unit may be 1 bit.

The accumulation circuit 140 may obtain the modular multiplication result, which is the final result, based on iterating the shift of the accumulation result for the loop length “l”. In this case, the modular multiplication result may be defined as (AB−r)R⁻¹ mod N.

According to the embodiments described above, the multiplier 100 may defend against side-channel attacks on modular multiplication operations with a computational cost that is less than when masking is applied to modular exponentiation by performing masking-based Montgomery operations.

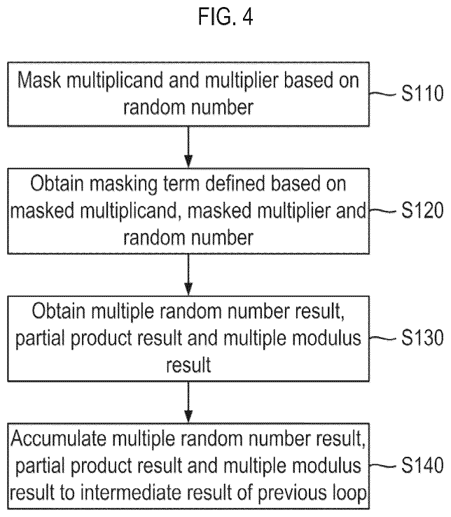

FIG. 4 is a flowchart of an operating method of a multiplier, according to some embodiments. In some embodiments, the operating method may be performed by the multiplier 100 described above.

Referring to FIG. 4, in operation S110, a multiplier may mask a multiplicand and a multiplier based on a random number. Through operation S110, a masked multiplicand and a masked multiplier may be obtained.

In operation S120, the multiplier may obtain a masking term defined based on the masked multiplicand, the masked multiplier, and the random number. For example, operation S120 may be performed based on Equation 8.

In operation S130, the multiplier may obtain a multiple random number result, which is a result of a multiplication operation on the random number and the masking term, a partial product result, which is a result of a multiplication operation on the masked multiplicand and the masked multiplier, and a multiple modulus result, which is a result of a multiple modulus operation on a modulus and a quotient on the modulus. Each result may be obtained through the multiple random number operation, the partial product operation, and the multiple modulus operation.

For example, the first intermediate operation circuit (refer to FIG. 3) of the multiplier may obtain a multiple random number result through a multiplication operation on the i-th bit of the random number and the masking term in the i-th loop (where “i” is “0” to “l”−1).

For example, the second intermediate operation circuit (refer to FIG. 3) of the multiplier may obtain a partial product result through a multiplication operation on the masked multiplicand and the i-th bit of the masked multiplier in the i-th loop. In addition, in the i-th loop, the second intermediate operation circuit may obtain the multiple modulus result through a multiple modulus operation on the quotient and the modulus.

In operation S140, the multiplier may accumulate the partial product result, the multiple modulus result, and the multiple random number result obtained through operation S130 up to the intermediate result of the previous loop. In this case, the intermediate result of the previous loop may be defined as the accumulation result of the (i−1)-th loop.

In some embodiments, the operation S140 may further include an operation of shifting the accumulation result such that the last bit of the accumulation result becomes “0”. For example, the shift may be performed in units of 1 bit from the LSB direction to the MSB direction (or from the MSB direction to the LSB direction). The intermediate result of the current loop is obtained as the shifted accumulation result.

In some embodiments, the operating method may further include an operation of obtaining a modular multiplication result based on iterating the shift of the accumulation result for the loop length “l”. In detail, when the iterated execution of the operations S120 and S140 for the loop length “l” is completed, the modular multiplication result may be obtained as the final result.

The operating method according to the above described embodiments may defend against side channel attacks with a computational cost that is less than when masking is applied to the modular exponentiation by masking the inputs (the multiplicand and the multiplier) of the modular multiplication operation.

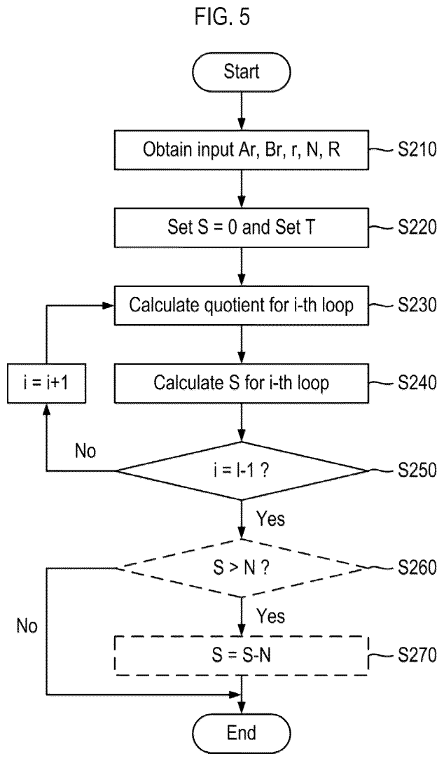

FIG. 5 is a flowchart of an operating method of a multiplier, according to some embodiments.

Referring to FIG. 5, in operation S210, the multiplier may obtain the masked multiplicand Aᵣ, the masked multiplier Bᵣ, the random number “r”, the modulus “N”, and the Montgomery constant “R” as inputs of a masking-based Montgomery operation.

In operation S220, the multiplier may set the intermediate result “S” to the initial value “0”, and may set (or obtain) a masking term “T”.

In operation S230, the multiplier may calculate a quotient for the i-th loop. For example, operation S230 may be performed based on adding a partial product result (e.g., a partial product for a 0-bit multiplicand) and a multiple random number result (e.g., a multiple random number for a 0-bit masking term) to the intermediate result set as the initial value.

In operation S240, the multiplier may calculate an intermediate result for the i-th loop. For example, operation S240 may be performed based on summing the (i−1)-th intermediate result, the partial product result, the multiple modulus result, and the multiple random number result, and shifting the sum result.

In operation S250, the multiplier may determine whether the loop index “i” is “l”−1, and when “i” is not “l”−1 (operation S250, No), may add “1” to “i”, and then may iteratively perform operations S230 to S250.

When the loop for the loop length “l” is terminated (i.e., when “i”=“l”−1 in operation S250) (operation S250, Yes), in operation S260, the multiplier may determine whether the intermediate result “S” is greater than the modulus “N”. When the intermediate result “S” is less than or equal to the modulus “N” (operation S260, No), the intermediate result “S” is obtained as the final result.

Alternatively, when the intermediate result “S” is greater than the modulus “N” (operation S260, Yes), in operation S270, the multiplier may obtain the value obtained by subtracting the modulus “N” from the intermediate result “S” as the final result.

According to some embodiments, operations S260 to S270 may be omitted when the loop length “l” and the Montgomery constant “R” are set to specific values. For example, when the loop length “l” is set to k+2 and the Montgomery constant “R” is set to 2^{k+2}, the subtraction operation through operations S260 to S270 may be omitted. Here, “k” is the bit size of the multiplicand, the multiplier, and the modulus.

The operating method of the masking-based Montgomery operation according to some embodiments may be implemented as illustrated in Table 2 below.

TABLE 2

| Input | Aᵣ, Bᵣ, r, N, R, N′ |
|---|---|
| Output | (AB − r)R⁻¹ mod N |
| 1 | S = 0 |
| 2 | T = Aᵣ + Bᵣ + r − 1 |
| 3 | For i = 0 to l − 1 |
| 4 | qᵢ = (s₀ + bᵣ_{ᵢ}aᵣ_{₀}+ rᵢt₀) N′ mod b |
| 5 | S = (S + bᵣ_{ᵢ}Aᵣ + rᵢT + qᵢN) / b |
| 6 | If (S > N) then S = S − N |
| 7 | Return S |

Referring to Table 2, the final result S=(sₗ, sₗ₋₁, . . . , s₁, s₀)₂ for the loop length “l” is output through the masking-based Montgomery operation. In Table 2, N′ is defined as the Montgomery inverse of the modulus “N” and may satisfy 0<N′<R. The “b” is the same as the Montgomery constant “R”.

First, the result “S” is set to the initial value “0” (line 1 of Table 2)

In addition, the masking term “T” is set or calculated (line 2 of Table 2).

In addition, in the i-th operation of the loop length “l”, the product of bᵣᵢ corresponding to the i-bit in the masked multiplier and aro corresponding to the 0-bit in the masked multiplicand is added to so, which is the 0-bit of the “S”. The result of the addition is expressed as a value of “0” or “1” through (s₀+bᵣ_{ᵢ}aᵣ_{₀}+rᵢt₀)N′ mod b. As a result, the quotient qᵢ is calculated (line 4 of Table 2).

The qᵢ indicates whether the last digit of the result of the product of the multiplicand and the multiplier in the i-th operation is “0” or “1”.

Next, in the i-th operation, the new intermediate result “S” is updated (line 4 of Table 2). In detail, the product of bᵢ corresponding to the i-th digit of the multiplier and the multiplicand “A” is added to the previous intermediate result “S”, and additionally, a modulus may be added depending on the value of the qᵢ. When qᵢ is “0”, the modulus is not added. By dividing the sum result (S+bᵢA+qᵢN) by “b”, the sum result may be shifted.

Lines 3 and 4 of Table 2 are iteratively performed with respect to the loop length “1”.

Thereafter, when the accumulation result S=(sₗ, sₗ₋₁, . . . , s₁, s₀)₂ for the loop length “l” is greater than the modulus “N”, the value (line 6 in Table 2) obtained by subtracting the modulus “N” from the result “S” is calculated as the final result. Since “S” may have a value greater than or equal to “0” and less than 2N, line 6 of Table 2 subtracts the size of the “S”.

The operating method of the masking-based Montgomery operation according to some embodiments may be implemented based on a Radix-2. In the case of the Radix-2, “b” in Table 2 is defined as “2”. The Radix-2-based operation method may be performed based on Table 3 below.

TABLE 3

| Input | Aᵣ, Bᵣ, r, N, R |
|---|---|
| Output | (AB − r)R⁻¹ mod N |
| 1 | S = 0 |
| 2 | T= Aᵣ + Bᵣ + r − 1 |
| 3 | For i = 0 to l − 1 |
| 4 | qᵢ = s₀ + bᵣ_{ᵢ}aᵣ_{₀}+ rᵢt₀ mod 2 |
| 5 | S = (S + bᵣ_{ᵢ}Aᵣ + rᵢT + qᵢN) / 2 |
| 6 | If (S > N) then S = S − N |
| 7 | Return S |

Referring to Table 3, first, the result “S” and the term “T” are set or calculated (lines 1 and 2 of Table 3).

In addition, in the i-th operation of the loop length “l”, the product of bᵣᵢ corresponding to the i-bit in the masked multiplier and aro corresponding to the 0-bit in the masked multiplicand is added to so, which is the 0-bit of the “S”. The result of the addition is expressed as a value of “0” or “1” through modular 2. As a result, the quotient qᵢ is calculated (line 4 of Table 3).

Next, in the i-th operation, the new intermediate result “S” is updated (line 5 of Table 3). Since the sum result (S+bᵢA+qᵢN) is divided by “2”, the last digit (i.e., “0”) of the sum result is deleted. Therefore, line 5 of Table 3 may be understood as shifting the sum result (S+bᵢA+qᵢN) by one digit.

Lines 4 and 5 of Table 3 are iteratively performed with respect to the loop length “l”.

Thereafter, when the accumulation result S=(sₗ, sₗ₋₁, . . . , s₁, s₀)₂ for the loop length “l” is greater than the modulus “N”, the value (line 6 in Table 3) obtained by subtracting the modulus “N” from the result “S” is calculated as the final result. Since “S” may have a value greater than or equal to “0” and less than 2N, line 6 of Table 3 subtracts the size of “S”.

According to the embodiments described above, line 6 of Tables 2 and 3 may be omitted when the loop length “l” and the Montgomery constant “R” are set to specific values.

In Tables 2 and 3, the addition operation is performed based on a carry-propagate addition, and according to the embodiments, the carry-propagate addition of Tables 2 and 3 may be implemented through a carry-save adder (CSA). In this case, the intermediate value “S” of Tables 2 and 3 may be modified to a carry-save representation (e.g., a stored value and a carry value). Even in implementations through the CSA, a carry-propagate adder (CPA) may be required for operations such as addition of multiple operands through the CSA or conversion of carry-save format to conventional format.

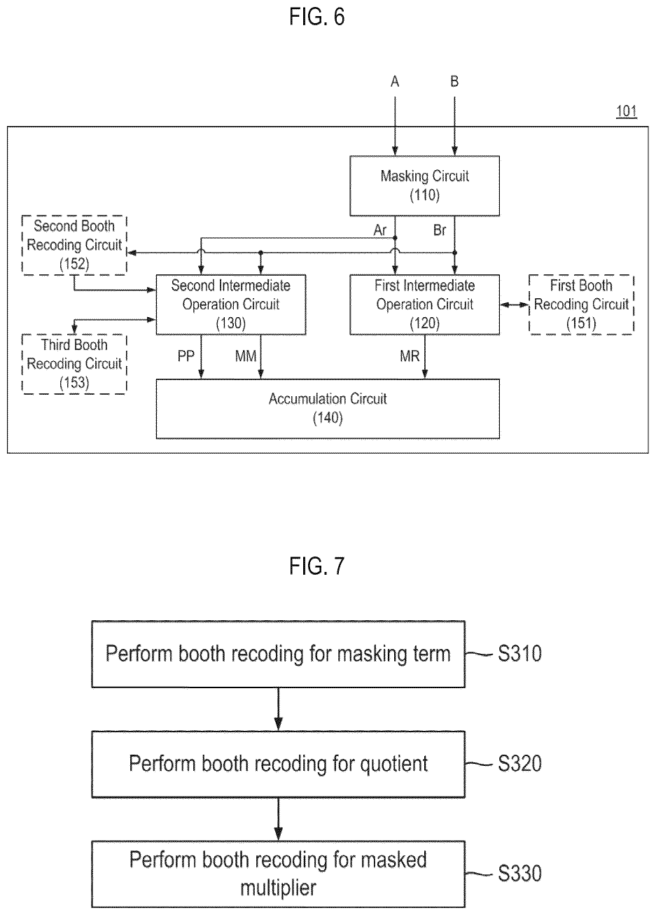

FIG. 6 is a block diagram of a multiplier, according to some embodiments.

Referring to FIG. 6, a multiplier 101 according to some embodiments may further include a first booth recoding circuit 151, a second booth recoding circuit 152, and a third booth recoding circuit 153 in addition to the masking circuit 110, the first intermediate operation circuit 120, the second intermediate operation circuit 130, and the accumulation circuit 140 of FIG. 3. Hereinafter, an additional description of the configuration overlapping with the configuration of FIG. 3 described above will be omitted to avoid redundancy and for conciseness.

The first booth recoding circuit 151 may be connected to the first intermediate operation circuit and may be configured to perform a first booth recoding for the masking term. The booth recoding is an algorithm that performs multiplication while processing the bits of the operand according to a booth recoding rule, to reduce the computational cost of the multiplication operation. Through the booth recoding, the operand may be converted into a signed bit while adjacent bits of the operand are compared.

The first booth recoding circuit 151 may perform the first booth recoding on a masking term to be multiplied by a random number through the first intermediate operation circuit 120, and may output the booth-recoded masking term as a result of the first booth recoding to the first intermediate operation circuit 120.

Through the first booth recoding circuit 151, the computational cost for outputting the multiple random number result MR of the first intermediate operation circuit 120 may be reduced.

The second booth recoding circuit 152 may be connected to the second intermediate operation circuit 130 and may be configured to perform a second booth recoding for a masked multiplier. The second booth recoding circuit 152 may perform the second booth recoding on the masked multiplier to be multiplied by the masked multiplicand in the partial product, and may output the booth-recoded masked multiplier to the second intermediate operation circuit as a result of the second booth recoding.

Through the second booth recoding circuit 152, the computational cost of the partial product of the second intermediate operation circuit 130 may be reduced.

The third booth recoding circuit 153 may be connected to the second intermediate operation circuit 130 and may be configured to perform a third booth recoding on the quotient. The third booth recoding circuit 153 may perform the third booth recoding on the quotient to be multiplied by the modulus in the multiple modulus, and may output the booth-recoded quotient as a result of the third booth recoding to the second intermediate operation circuit 130.

Through the third booth recoding circuit 153, the multiple modulus computational cost of the second intermediate operation circuit 130 may be reduced.

In some embodiments, at least one of the first booth recoding circuit to the third booth recoding circuit 151 to 153 may be omitted.

Through the booth recoding, the computational cost of the masking-based Montgomery operation may be reduced.

FIG. 7 is a flowchart of an operating method of a multiplier, according to some embodiments. In an embodiment, the operating method may be performed by the multiplier 101 described above.

Referring to FIG. 7, in operation S310, the multiplier may perform the first booth recoding for the masked term. In operation S320, the multiplier may perform the second booth recoding for the quotient. In operation S330, the multiplier may perform the third booth recoding for the masked multiplier. The operating method of FIG. 7 described above does not limit the time order of each operation (operation S310, operation S320, or operation S330). In detail, operations S310 to S330 may be performed in parallel, or some of operations may be started first.

When the booth recoding is performed, the operating method according to the embodiments described above (e.g., FIG. 4 and FIG. 5) may be performed based on the booth recoded result.

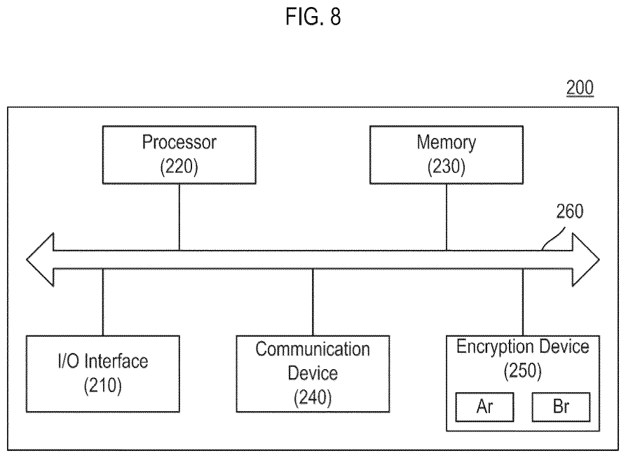

FIG. 8 illustrates an electronic device, according to some embodiments.

Referring to FIG. 8, an electronic device 200 according to some embodiments may include an input/output interface 210, a processor 220, a memory 230, a communication device 240, and an encryption device 250. In some embodiments, the I/O interface 210, the processor 220, the memory 230, the communication device 240, and the encryption device 250 may be electrically connected to each other through a bus 260. In some embodiments, at least some of the I/O interface 210, the processor 220, the memory 230, the communication device 240, and the encryption device 250 may be electrically connected to each other through the bus 260.

The I/O interface 210 may be configured to input/output data processed or data to be processed by components included in the electronic device 200.

The processor 220 may be connected to the memory 230 to control the memory 230, and may be configured to execute at least one instruction stored in the memory 230 to implement descriptions, functions, procedures, proposals, methods, and/or operating flowcharts of the present disclosure. In addition, the processor 220 may process information stored in the memory 230 to generate data.

According to some embodiments, each of the processors 220 may be a separate processor, or may be a core included in a multi-core processor. A multi-core processor may be a single computing component having two or more independent processors, and each of the processors 220 (or cores) may read and execute instructions.

According to some embodiments, the processor 220 may include one or more processing elements, which may be symmetric or asymmetric. The processing element may refer to a hardware or logic for supporting a software thread. For example, a hardware processing element may include a thread unit, a thread slot, a thread, a process unit, a context, a context unit, a logical processor, a hardware thread, and/or a core. In detail, the processing element may refer to any hardware that may be independently associated with a code such as a software thread, an operating system, an application, and/or other code.

According to some embodiments, the processor 220 may be implemented as a general-purpose processor, a dedicated processor, or an application processor (AP). For example, the processor 220 may be implemented as an operation processor (e.g., a central processing unit (CPU), a graphics processing unit (GPU), etc.) including a dedicated logic circuit (e.g., a field programmable gate array (FPGA), application specific integrated circuits (ASICs), etc.), but embodiments are not limited thereto.

The memory 230 may be connected to the processor 220 and may store various information related to the operation of the processor 220. For example, the memory 230 may store software code including at least one instruction for performing some or all of the processes or threads controlled by the processor 220, or for performing the descriptions, functions, procedures, proposals, methods, and/or operation flowcharts such as those describe above with reference to FIGS. 4, 5, and 7. For example, the software code may be implemented in a procedural or object-oriented programming language, or may be implemented in assembly language or machine language as required. In some embodiments, the software code may be implemented in a declarative programming language. In addition, the embodiments of the present disclosure are not limited to any specific programming language.

The memory 230 may include at least one of a volatile memory or a nonvolatile memory. The nonvolatile memory may include at least one of various memories such as a read only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (ReRAM), and/or a ferroelectric RAM (FRAM). The volatile memory may include at least one of various memories such as a static RAM (SRAM), a dynamic RAM (DRAM), and/or a synchronous DRAM (SDRAM).

Various types of data, such as security programs and files, may be installed and stored in the memory 230. For example, the memory 230 may store input data, public keys and/or private keys for encryption/decryption, encrypted data, or parameters for performing masking-based Montgomery operations according to the embodiments described above.

The communication device 240 may be, for example, a wired local area network (LAN), a wireless short range communication interface such as Bluetooth, Wi-fi, Zigbee, or a modem communication interface that may access to a mobile communication network such as a PLC, 3G, LTE, 4G, or 5G. The communication device 240 may include a transmitter and/or a receiver. The electronic device 200 may transmit and/or receive information to/from an access point or a gateway through the transmitter and/or the receiver. In addition, the electronic device 200 may communicate with a user device or another electronic device 200 to transmit and/or receive control information or data of the electronic device 200. The data may include data associated with the encryption device 250.

The encryption device 250 may be configured to encrypt and/or decrypt electronic data for security purposes. For example, the encryption device 250 may encrypt and decrypt electronic data using various public key algorithms (e.g., RSA algorithms, elliptic curve cryptography algorithms, DH algorithms, etc.) and secret key algorithms described above.

According to some embodiments, the encryption device 250 may perform modular multiplication operations and modular exponentiation operations used in encryption algorithms, based on masked multiplicands and masked multipliers, as described above with reference to FIGS. 3-7. The masked multiplicand and the masked multiplier may include operands masked with the random number “r”.

When the modular multiplication operation is used for encryption/decryption, the encryption device 250 may perform the masking-based Montgomery operation and described above with reference to FIGS. 3-7. For example, the encryption device 250 may obtain a masking term (e.g., Equation 8) defined based on the masked multiplicand Ar, the masked multiplier Bᵣ, and a random number, and may perform the Montgomery multiplication operation (i.e., the masking-based Montgomery operation) on the masked multiplicand and the masked multiplier based on the masking term.

The encryption device 250 may convert (AB−r)R⁻¹ mod N, which is the result of the masking-based Montgomery operation into an integer domain. For example, the encryption device 250 may convert (AB−r)R⁻¹ mod N into an integer domain through the characteristic 3. In addition, the encryption device 250 may restore AB by adding the random number “r”. Therefore, since the encryption device 250 may restore AB before masking by only adding the random number “r”, the computational cost for restoration may be reduced.

When a modular exponentiation operation is used for encryption/decryption, the encryption device 250 may perform the modular exponentiation operation by utilizing the masking-based Montgomery operation. For example, the encryption device 250 may perform a binary modular exponentiation operation according to Table 4 below.

TABLE 4

| | |
|---|---|
| 1 | R₀ ← 1 |
| 2 | For i from l − 1 to 0 |
| 3 | R₀ < R₀² mod N |
| 4 | if eᵢ = 1 then |
| 5 | R₀ − R₀ x X mod N |
| 6 | end if |
| 7 | end for |
| 8 | return R₀ |

Here, R₀ is an intermediate result or a final result, and “i”, “l”, and “N” are a loop index, a loop length, and a modulus, respectively. “X” is a basis value of modular exponentiation. In particular, “i” may represent each bit digit of the binary value of the exponent.

In line 1 of Table 4, R₀ is set to an initial value “1”. In line 3 of Table 4, R₀ is updated as a result of a modular operation on the square of R₀. In addition, when the value corresponding to the current i-th bit digit is “1” (line 4 of Table 4), R₀ is updated as a result of a modular operation on the value obtained by multiplying the “X” by the value updated in the line 3.

The overhead of modular exponentiation operation may be reduced through the binary modular exponentiation operation as in Table 4. In addition, a masking-based Montgomery operation described above with respect to FIGS. 3-7 may be applied to the modular multiplication operation required in Table 4.

First, the encryption device 250 may convert R₀ and “X” into the Montgomery domain through the characteristic 2. The R₀ is converted into the Montgomery constant “R”, and the “X” is converted into XR. The encryption device 250 may perform a masking-based Montgomery operation on the values converted into the Montgomery domain. Therefore, it is possible to defend against side-channel attacks on modular multiplication operations.

In addition, both line 3 of Table 4 and line 5 of Table 4 may be operated in the Montgomery domain. Therefore, the encryption device 250 may perform the modular multiplication according to line 3 and line 5 of Table 4 through the masking-based Montgomery operation. In this case, R₀ and “X” may be masked.

The electronic device 200 according to the above described embodiments may perform an encryption algorithm with a reduced computational cost while defending against side-channel attacks through the encryption device 250 capable of performing masking-based Montgomery operations.

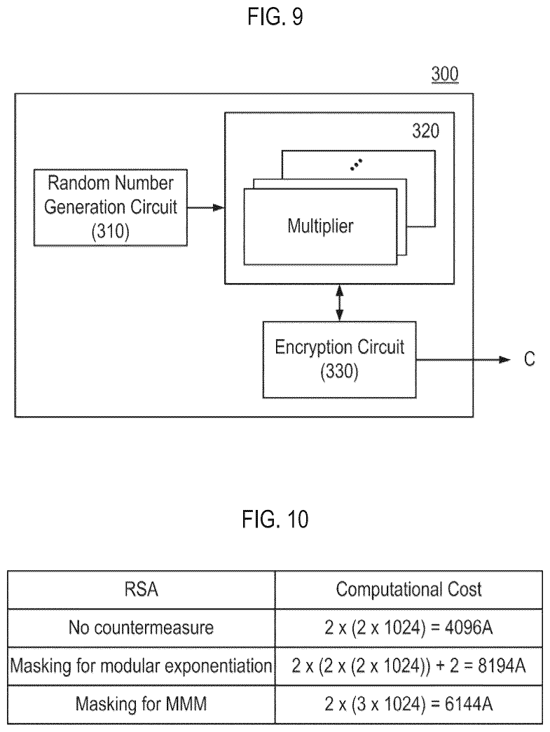

FIG. 9 illustrates an encryption device, according to some embodiments.

Referring to FIG. 9, an encryption device 300 according to some embodiments may include a random number generation circuit 310, one or more multipliers 320, and an encryption circuit 330. For example, in some embodiments, the encryption device 300 may be the encryption device of FIG. 8.

The random number generation circuit 310 may be configured to generate a random number. The generated random number may be used for masking, or may be used as a random number in an encryption algorithm.

The one or more multipliers 320 may be configured to perform the masking-based Montgomery operation according to the embodiments described above with respect to FIGS. 3-7. For example, each of the one or more multipliers 320 may mask the multiplicand and the multiplier based on the random number, may obtain a masking term defined based on the masked multiplicand, the masked multiplier, and the random number, and may perform a modular multiplication operation based on the masked multiplicand, the masked multiplier, the random number, and the masking term.

According to some embodiments, each of the one or more multipliers 320 may be implemented according to FIGS. 3 and 6.

The encryption circuit 330 may be configured to encrypt a message based on the one or more multipliers 320, and to obtain encrypted data corresponding to the encryption. For example, in the case of the RSA algorithm, the encryption circuit 330 may obtain encrypted data “C” based on Equation 3. To perform a modular exponentiation operation Me of Equation 3, the encryption circuit 330 may utilize a masking-based Montgomery operation through one or more multipliers 320.

The encryption device 300 according to the above described embodiments may perform an encryption algorithm with a reduced computational cost while defending against side-channel attacks by performing the modular multiplication operation through random number-based masking.

FIG. 10 is a table comparing a mathematical computational cost of encryption algorithms by way of example.

Referring to FIG. 10, assuming that the exponent (or the key) of the RSA encryption algorithm is 1024, the computational cost of the encryption algorithm (no countermeasure) without a defense method against the side-channel attack by way of example may be defined as 4096A. Here, “A” represents the number of addition operations, which are unit operations.

With respect to an encryption algorithm in which masking is applied to an exponent in a modular exponentiation operation, the computational cost may be calculated to be approximately twice that of an encryption algorithm without a defense method.

In contrast, in the case of a masking-based Montgomery (MMM) operation in which masking is applied to a modular multiplication operation according to some embodiments, it may be confirmed that the computational cost is calculated to be approximately 1.5 times that of an encryption algorithm without a defense method. In detail, in the case of a masking-based Montgomery operation according to some embodiments, there is an advantage of reducing the computational cost in comparison to defending against a side-channel attack in the modular exponentiation operation.

Additionally, when the masking-based Montgomery operation according to some embodiments is applied to an ECDSA, there is an advantage that masking is not required for “dr”.

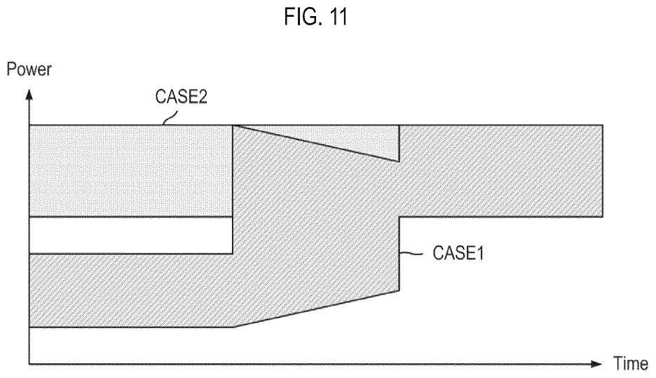

FIG. 11 illustrates trends of power waveforms of encryption algorithms by way of example.

Referring to FIG. 11, Case 1 represents a trend of power waveform for a general RSA encryption algorithm, and Case 2 represents a trend of power waveform for an RSA encryption algorithm to which a masking-based Montgomery (MMM) operation is applied according to some embodiments. In addition, it is assumed that all multiplicands have random values, and some upper bits of the multiplier have “0”.

In the case of Case 1, some upper bits of the multiplier have “0”, so a hamming weight is low. Therefore, the trend of the power waveform of Case 1 represents low power consumption in the section corresponding to the upper bits of the multiplier.

In contrast, in the case of Case 2, since masking is performed based on a random number, intermediate values of the modular multiplication operation process may be randomized. Therefore, in Case 2, the power consumption of the entire section represents a uniform trend.

Finally, according to the embodiments of the present disclosure, it is possible to defend against a side-channel attack that backtracks the waveform of power consumption.

In addition, since the modular multiplication operation consumes more power than the processor operation, a waveform identifier may be created with respect to one operation. Based on the waveform identifier, the number of times that the multiplication is invoked may be calculated. For example, an encryption algorithm of x-bit (where “x” is a natural number) may perform “x” modular multiplication operation loops, and the number of loops may be confirmed through the power waveform as in FIG. 11.

When masking based on random numbers is performed as in Case 2, in addition to the basic modular multiplication operation loop, more loop counts may be confirmed from the waveform due to the masking.

According to various embodiment of the present disclosure, the multiplier for a masking-based modular multiplication operation, and an encryption device and method including the same may be provided.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A multiplier device comprising:
a masking circuit configured to mask a multiplicand and a multiplier based on a random number, to obtain a masked multiplicand and a masked multiplier, respectively;
a first intermediate operation circuit configured to obtain a masking term defined based on the masked multiplicand, the masked multiplier, and the random number, and to obtain a multiple random number result through a multiplication operation of the random number and the masking term;
a second intermediate operation circuit configured to obtain a partial product result for the masked multiplicand and the masked multiplier, and a multiple modulus result for a modulus and a quotient of the modulus; and
an accumulation circuit configured to accumulate the partial product result, the multiple modulus result, and the multiple random number result up to an intermediate result of a previous loop.

2. The multiplier device of claim 1, wherein the masking term is defined as Aᵣ+Bᵣ+r−1,
where Aᵣ is the masked multiplicand,
Bᵣ is the masked multiplier, and
r is the random number.

3. The multiplier device of claim 1, wherein the quotient is a sign indicating whether to add the modulus based on the intermediate result, the partial product result, and the multiple random number result.

4. The multiplier device of claim 1, further comprising:
a first booth recoding circuit configured to perform a first booth recoding on the masking term and to output a first booth recoding result of the first booth recoding to the first intermediate operation circuit.

5. The multiplier device of claim 1, further comprising:
a second booth recoding circuit configured to perform a second booth recoding on the masked multiplier and to output a second booth recoding result of the second booth recoding to the second intermediate operation circuit; and
a third booth recoding circuit configured to perform a third booth recoding on the quotient and to output a third booth recoding result of the third booth recoding to the second intermediate operation circuit.

6. The multiplier device of claim 1, wherein the first intermediate operation circuit is configured to:
obtain the multiple random number result by performing a multiplication operation on an i-th bit of the random number and the masking term in an i-th loop (where i is 0 to l−1, and l is a natural number greater than 2 as a loop length).

7. The multiplier device of claim 6, wherein the second intermediate operation circuit is configured to:
obtain the partial product result through a multiplication operation for an i-th bit of the masked multiplicand and the masked multiplier in the i-th loop.

8. The multiplier device of claim 6, wherein the intermediate result of the previous loop is defined as an accumulation result of the (i−1)-th loop.

9. The multiplier device of claim 1, wherein the accumulation circuit is configured to shift an accumulation result such that a last bit of the accumulation result becomes 0.

10. The multiplier device of claim 9, wherein the accumulation circuit obtains a modular multiple result based on iterating the shift of the accumulation result with respect to a loop length l (where l is a natural number greater than 2).

11. The multiplier device of claim 10, wherein the modular multiple result is defined as (AB−r)R⁻¹ mod N,
where A is the multiplicand,
B is the multiplier,
r is the random number,
R is a Montgomery constant defined as 2^{k},
k is a bit size of the multiplicand, the multiplier and the modulus, and
N is the modulus.

12. A method of operating a multiplier device, the method comprising:
masking a multiplicand and a multiplier based on a random number, to obtain a masked multiplicand and a masked multiplier, respectively;
obtaining a masking term defined based on the masked multiplicand, the masked multiplier, and the random number;
obtaining a multiple random number result, which is a result of a multiplication operation of the random number and the masking term, a partial product result for the masked multiplicand and the masked multiplier, and a multiple modulus result for a modulus and a quotient for the modulus; and
accumulating the partial product result, the multiple modulus result, and the multiple random number result up to an intermediate result of a previous loop.

13. The method of claim 12, wherein the masking term is defined as Aᵣ+Bᵣ+r−1,
where Aᵣ is the masked multiplicand,
Bᵣ is the masked multiplier, and
r is the random number.

14. The method of claim 12, further comprising:
performing a booth recoding on the masking term, the quotient, and the masked multiplier.

15. The method of claim 12, further comprising:
shifting an accumulation result such that a last bit of the accumulation result becomes 0.

16. The method of claim 15, further comprising:
obtaining a modular multiple result based on iterating the shifting of the accumulation result with respect to a loop length l (where l is a natural number greater than 2).

17. The method of claim 16, wherein the modular multiple result is defined as (AB−r)R⁻¹ mod N,
where A is the multiplicand,
B is the multiplier,
r is the random number,
R is a Montgomery constant defined as 2^{k},
k is a bit size of the multiplicand, the multiplier and the modulus, and
N is the modulus.

18. An encryption device comprising:
a random number generation circuit configured to generate a random number;
one or more multiplier devices configured to mask a multiplicand and a multiplier based on the random number, thus obtaining a masked multiplicand and a masked multiplier, respectively, to obtain a masking term defined based on the masked multiplicand, the masked multiplier, and the random number, and to perform a modular multiplication operation based on the masked multiplicand, the masked multiplier, the random number, and the masking term; and
an encryption circuit configured to perform encryption to encrypt a message based on the one or more multiplier devices, and to obtain encrypted data corresponding to the encryption.

19. The encryption device of claim 18, wherein the masking term is defined as Aᵣ+Bᵣ+r−1,
where A, is the masked multiplicand,
Bᵣ is the masked multiplier, and
r is the random number.

20. The encryption device of claim 18, wherein the one or more multiplier devices are configured to:
obtain a multiple random number result through a multiplication operation for the random number and the masking term,
obtain a partial product result for the masked multiplicand and the masked multiplier, and a multiple modulus result for a modulus and a quotient for the modulus, and
accumulate the partial product result, the multiple modulus result, and the multiple random number result up to an intermediate result of a previous loop.
